(19) United States
(12) Patent Application Publication
(10) Pub. No.: US 2024/0382896 A1
(43) Pub. Date: Nov. 21, 2024

(54) Ammonia Cracking for Green Hydrogen

(71) Applicant: Air Products and Chemicals, Inc., Allentown, PA (US)

(72) Inventors: Edward Landis Weist, Jr., Macungie, PA (US); Shubhra J. Bhadra, Macungie, PA (US); William J. Casteel, Jr., Fountain Hill, PA (US); Timothy C. Golden, Nevez (FR); Jeffrey R. Hufton, Fogelsville, PA (US); Garret C. Lau, New Tripoli, PA (US); Simon Craig Saloway, Surrey (GB)

(73) Assignee: Air Products and Chemicals, Inc., Allentown, PA (US)

(21) Appl. No.: 18/569,865

(22) PCT Filed: Jun. 18, 2021
(86) PCT No.: PCT/US2021/038004

§ 371 Date: Dec. 13, 2023

(51) Int. Cl. B01D 53/047; C01B 3/04; C01B 3/56

(52) U.S. Cl. CPC B01D 53/047; C01B 3/047; C01B 3/56; B01D 2253/102; B01D 2253/104; B01D 2253/108; B01D 2256/16; B01D 2257/102; B01D 2257/406; B01D 2257/80; C01B 2203/0277; C01B 2203/043; C01B 2203/0883

(57) ABSTRACT

Residual ammonia is removed effectively from ammonia cracked gas in a hydrogen PSA system using a non-zeolitic adsorbent such as activated carbon, activated alumina or silica gel.

### BACKGROUND

Global interest in renewable energy and using this renewable energy to generate green hydrogen has driven the interest in converting the green hydrogen to green ammonia, as ammonia is simpler to transport over distance of hundreds or thousands of miles. Particularly, shipping liquid hydrogen is not commercially possible currently but shipping ammonia, which is in a liquid state, is currently practiced.

For use in a commercial fuel cell, the ammonia must be converted back to hydrogen according to the reaction.

$$2 {NH}_{3} ⇌ 3 {H}_{2} + {N}_{2}$$

This is an endothermic process, i.e., a process that requires heat, and is performed over a catalyst. This process is known as cracking. The gas produced (or “cracked gas”) is a combination of hydrogen (H₂) and nitrogen (N₂). Since the cracking reaction is an equilibrium reaction, the conversion of ammonia as given by the reaction equation is less than 100%, and there will be residual ammonia in the reactor effluent. In most applications of crackers currently, the hydrogen+nitrogen mixture is utilised as is. However, as ammonia can be a poison to fuel cells, this stream, with ammonia suitably removed such as by scrubbing with water, can be used directly in a fuel cell. However, if the hydrogen is to be used in vehicle fueling, the nitrogen present provides a penalty to the process. The fuel to a vehicle fueling system is compressed to significant pressure—up to 900 bar. This means that the nitrogen, which is merely a diluent in the process, is also compressed, taking power, and taking storage volume and increasing anode gas purge requirement, decreasing efficiency. It is therefore beneficial where hydrogen is to be used in vehicle fueling, for the hydrogen+nitrogen to be purified.

Small scale cracking reactors, or “crackers”, typically use pressure swing adsorption (“PSA”) devices to separate the cracked gas and recover the hydrogen and generate a PSA tail gas (or offgas). However, these crackers are generally heated electrically and the PSA tail gas is typically vented to atmosphere.

As is common in hydrogen production from a steam methane reforming (SMR) reactor, a PSA can be used to purify the nitrogen+hydrogen. The cracking reaction is performed in tubes packed with catalyst which are externally heated by a furnace (see GB1142941).

GB1142941 discloses a process for making town gas from ammonia. The ammonia is cracked and the cracked gas scrubbed with water to remove residual ammonia. The purified hydrogen/nitrogen mixture is then enriched with propane and/or butane vapor to produce the town gas for distribution.

U.S. Pat. No. 6,835,360A discloses an endothermic catalytic reaction apparatus for converting hydrocarbon feedstock and methanol to useful gases, such as hydrogen and carbon monoxide. The apparatus comprises a tubular endothermic catalytic reactor in combination with a radiant combustion chamber. The resultant cracked gas is used directly in a fuel cell after passing through a gas conditioning system.

GB977830A discloses a process for cracking ammonia to produce hydrogen. In this process, the hydrogen is separated from the nitrogen by passing the cracked gas through a bed of molecular sieves which adsorbs nitrogen. The nitrogen is then driven off the bed and may be stored in a holder.

JP5330802A discloses an ammonia cracking process in which the ammonia is contacted with an ammonia decomposition catalyst at a pressure of 10 kg/cm² (or about 9.8 bar) and a temperature of 300 to 700° C. Hydrogen is recovered from the cracked gas using a PSA device. The reference mentions that the desorbed nitrogen may be used to boost the upstream, process but no details are provided.

US2007/178034A discloses a process in which a mixture of ammonia and hydrocarbon feedstock is passed through a fired steam reformer at 600° C. and 3.2 MPa (or about 32 bar) where it is converted into a synthesis gas containing about 70 vol. % hydrogen. The synthesis gas is enriched in hydrogen in a shift reaction, cooled and condensate removed. The resultant gas is fed to a PSA system to generate a purified hydrogen product having 99 vol. % hydrogen or more. The offgas from the PSA system is fed as fuel to the fired steam reformer.

CN111957270A discloses a process in which ammonia is cracked in a tubular reactor within a furnace. The cracked gas is separated by adsorption to produce hydrogen gas and a nitrogen-rich offgas. The fuel demand of the furnace appears to be satisfied using a combination of cracked gas, hydrogen product gas and/or offgas.

The gas phase effluent of an ammonia cracking reactor is typically cooled to a temperature in a range from about 15° C. to about 60° C. and a pressure in a range from about 10 to 40 bar and contains a 3:1 mixture of hydrogen and nitrogen, together with some residual (or unconverted) ammonia, usually in the range of about 0.5 vol. % to 5 vol. %. In some instance, low levels of water vapor, e.g. from 0 to 0.5 vol. %, may also be present.

To produce a usable hydrogen stream from the ammonia cracking reactor effluent, a purification step is typically needed. As mentioned above, the nitrogen can be removed from the effluent stream by an adsorption process, such as hydrogen PSA. The ammonia can be removed prior to the hydrogen PSA step to very low levels (e.g. less than 50 ppm) by washing with chilled water. Following the chilled water wash, the dissolved ammonia is then stripped from the water with heat and recovered for further processing. Such scrubbing and stripping processes are, however, energy intensive.

U.S. Pat. No. 3,111,387 discloses an alternative process for removing residual ammonia from the effluent of an ammonia cracking reactor. In this process, the effluent gas is passed through a bed of zeolitic molecular sieve material having apparent pore sizes of at least 4 Å (or 0.4 nm) to remove simultaneously the nitrogen, ammonia and moisture from the gas, leaving substantially pure hydrogen product gas to exit the bed. The reference exemplifies cooling a cracked gas at a pressure of 200 psi (or 14 bar) to −20° F. (or −29° C.) and then passing the cooled gas through a bed of calcium zeolite A (i.e. 5A zeolite) in a PSA system to produce the hydrogen product gas. The zeolitic adsorbent bed is regenerated under vacuum.

The inventors have, however, realized that ammonia is adsorbed very strongly to such zeolitic materials which makes it difficult to remove all of the ammonia when regenerating the bed. The inventors expect that this is the reason that vacuum regeneration is used in U.S. Pat. No. 3,111,387. Over time (and many PSA cycles), ammonia could build up in the bed and eventually breakthrough into the hydrogen product gas which would of course be highly undesirable.

There is a need therefore generally for improved processes for the production of hydrogen from ammonia and specifically for processes that are more efficient in terms of energy consumption and/or that have higher levels of hydrogen recovery and/or that reduce or eliminate the need to combust fossil fuels.

Throughout the specification, including the following discussion of embodiments of the present invention, the pressures given are absolute pressures unless otherwise stated.

### BRIEF SUMMARY OF THE INVENTION

According to a first aspect of the present invention, there is provided a method of separating hydrogen gas from an effluent gas of an ammonia cracking reactor operating at an elevated pressure, in a PSA system comprising at least two PSA units in parallel, said method comprising:
cooling the effluent gas by heat exchange to produce cooled effluent gas; and
feeding the cooled effluent gas at the elevated pressure to the PSA system to produce a hydrogen product gas and a PSA tail gas;
   wherein each PSA unit comprises a feed end, a product end downstream from the feed end and an adsorbent bed located therebetween, the adsorbent bed comprising an upstream layer of non-zeolitic adsorbent that is selectively adsorbent for at least ammonia and a downstream layer of zeolitic adsorbent that is selectively adsorbent for nitrogen.

The expression “elevated pressure” is intended to mean a pressure that is substantially greater than atmospheric pressure, e.g. at least 5 bar, and is intended to include operating pressures disclosed herein for the ammonia cracker, e.g. from about 5 bar to about 50 bar.

The terms “upstream” and “downstream” are intended to identify the relative locations of the layers of non-zeolitic adsorbent and zeolitic adsorbent within the bed with reference to the direction of flow of the cooled effluent gas through the PSA unit during an adsorption phase of a PSA cycle. Thus, the upstream layer will be nearer the feed end (but further away from the product end) of the unit than the downstream layer.

The expression “selectively adsorbent” is intended to mean that the gas in question is more strongly adsorbed on to the adsorbent material than hydrogen gas. The term “selectively co-adsorbs” used herein will be interpreted accordingly.

A hydrogen PSA system utilizing the present invention is capable of handling the reactor effluent with its percent levels of ammonia, thereby eliminating the process steps of washing and stripping, and the energy required to chill and heat the water.

In addition, the inventors have discovered that non-zeolitic adsorbent materials are unexpectedly better suited for removing percent levels of ammonia from effluent gas of an ammonia cracking reactor during a hydrogen PSA process as such materials do not adsorb ammonia as strongly as a zeolitic material. This lower strength of adsorption reduces and potentially eliminates the problem of ammonia “creep” through the adsorbent bed over time.

Suitable non-zeolitic adsorbents may have a capacity for ammonia of at least 0.01 mmol/g and optionally no more than about 2 mmol/g at 0.005 bar and 40° C. For example, the ammonia capacity is typically in a range from about 0.01 mmol/g to about 2 mmol/g, e.g. from about 0.01mmol/g to about 0.5 mmol/g, or from about 0.01 mmol/g to about 0.3 mmol/g, at these conditions.

Suitable non-zeolitic adsorbents may desorb at least 10%, preferably at least 25%, more preferably at least 45%, of adsorbed ammonia after 100 seconds(s) using a nitrogen purge at 1.4 bar. These percentages refer to the proportion of adsorbed molecules that are desorbed during a purge step, e.g. when the bed is regenerated.

Suitable non-zeolitic adsorbents may desorb at least 30%, preferably at least 50%, more preferably at least 90%, of adsorbed ammonia after 600 s using a nitrogen purge at 1.4 bar at 40° C.

The inventors note that the adsorbent layers are typically purged with substantially pure hydrogen but, because nitrogen is adsorbed on to the downstream layer at the start of the purge step, a mixture of hydrogen and desorbed nitrogen will actually purge the ammonia layer in the process.

In some preferred embodiments, suitable non-zeolitic adsorbents also selectively co-adsorb water. In this regard, the capacity of the non-zeolitic adsorbent for water may be at least 1.8 wt. %, optionally no more than 5 wt. %, at a water partial pressure of 0.02 bar and 40° C. (see Table 1).

TABLE 1

| | Water capacity at 0.1%, |
|---|---|
| Adsorbent | 20 bar, 40 C. (wt %) |
| 5A zeolite | 22.1 |
| Small pore gel | 16.4 |
| Alumina | 12.6 |
| Wide pore gel | 3.6 |
| Coal-based carbon | 3.5 |
| Coconut-based carbon | 2.9 |
| Polymer-derived carbon | 1.8 |

In these embodiments, it may be possible to reduce the size of (or even avoid entirely) an additional layer of adsorbent in front of the upstream layer at the feed end of the bed dedicated to water removal.

Additionally or alternatively, suitable non-zeolitic adsorbents may also selectively co-adsorb nitrogen. In this regard, the capacity of the non-zeolitic material for nitrogen may be at least 0.18mmol/g, e.g. at least 0.7 mmol/g, at 5 bar and 40° C. In these embodiments, it may be possible to reduce the size of the layer of zeolitic adsorbent downstream of the upstream layer of non-zeolitic adsorbent.

Particularly suitable non-zeolitic adsorbents may a surface acidity (as measured as the zero point of charge or ZPC) in the range from about pH 6.3 to about pH 9.8, e.g. from about pH 8 to about pH 9. The ZPC is determined by adding 2 grams of adsorbent to 10 milliliters of deionized water and measuring pH of the water after 20 hours.

In some preferred embodiments, the non-zeolitic adsorbent is an activated carbon, e.g. selected from the group consisting of synthetic (i.e. polymer-derived) carbon, petroleum pitch carbon, wood-based carbon, coal-based carbon and coconut shell carbon. These carbons are formed by carbonization (i.e. heating between about 300° C. and about 900° C. in the absence of air) of particles of the precursor material, usually biomatter such as petroleum pitch, wood, coal or coconut shell. Polymer-derived carbons are typically formed by carbonization of globules of polymers such as polystyrene, polyacrylate, polyalkylamine, phenol-formaldehyde resin, or sulfonated co-polymers of styrene with divinyl benzene or with acrylic acid, or mixtures thereof.

Any of the activated carbons may be pre-treated with acid or base prior to being loaded into the bed, or pre-treated in situ by flowing nitrogen through the layer of activated carbon at an elevated temperature of at least 100° C., e.g. about 150° C., or at least 300° C., e.g. about 340° C. In situ pre-treatment in this way has the effect of reducing oxygen functionality and the acid nature of the surface of the carbon (see Water Research vol. 31, p 3414, 1998; and Carbon vol. 37, p 1379, 1999).

Particularly suitable carbon adsorbents have an inorganic content of less than 8 wt. %, e.g. less than 4 wt. %, less than 1 wt. %, less than 0.5 wt. % or even less than 0.2 wt. %. Such adsorbents may be referred to as “low ash” adsorbents. Such materials have particularly high sorption reversibility towards ammonia, e.g. at least 50% or even at least 90% of adsorbed ammonia is desorbed within 600 seconds when the bed is regenerated in flowing nitrogen at 1.4 bar and 40° C.

In other embodiments, the non-zeolitic adsorbent is activated alumina, perhaps activated alumina that has been pre-treated with base.

In further embodiments, the non-zeolitic adsorbent is selected from the group consisting of wide pore silica gel, narrow pore silica gel and silicalite.

The different adsorbents are layered in a vessel to form a bed to remove the water vapor, ammonia, and nitrogen from the gas stream. Thus, in the direction of the feed gas flowing through the adsorbent layers within the vessel, as the most strongly adsorbed molecule, the water vapor is removed first; the ammonia is removed second; and as second least adsorbed molecule, the nitrogen is removed last. As the least adsorbed molecule, hydrogen passes through the adsorbent layers relatively unadsorbed.

The adsorbent bed may comprise one or two layers non-zeolitic adsorbent(s) to remove water and ammonia, together with one or two layers of zeolitic adsorbent(s) for removing nitrogen.

In other embodiments, the adsorbent bed may comprise an intermediate layer of activated carbon having an inorganic content of less than 1% located between the upstream and downstream layers. Examples of such activated carbons include polymer-derived carbon, petroleum pitch carbon and wood-based carbon. Since ammonia is readily desorbed from them, these “low ash” materials can be used as second non-zeolitic (carbon) layer between a first non-zeolitic (e.g. carbon) layer having high ammonia adsorption capacity, and the downstream layer of zeolitic adsorbent (e.g. molecular sieve) used for adsorption of nitrogen in the PSA process. With easy desorption from the second non-zeolitic layer during the purge step, such an arrangement of layers will prevent the ammonia from reaching the molecular sieve.

Other adsorbents for water removal in PSA processes are well known. The materials commonly used for water adsorption are activated alumina, silica gel and carbon. In some embodiments, the adsorbent bed will have an initial layer of one of these materials at the feed end.

Zeolitic adsorbents for nitrogen removal in PSA processes are also well known. The materials commonly used for nitrogen adsorption are zeolites or molecular sieves, such as 13X, LiX, LiLSX, CaX, CaA (5A), and Ca-Chabazite. In the purification of the hydrogen from an ammonia cracking reactor, one or more of these materials may be utilized for nitrogen removal.

Examples of packed beds suitable for removing water, ammonia and nitrogen from the effluent of an ammonia cracking reactor to produce substantially pure hydrogen include (from feed end to product end):

$$activated alumina / activated carbon ( e . g . coal - based or coconut - based carbon ) / 5 A zeolite$$

$$activated alumina / narrow pore silica gel / 5 A zeolite$$

$$activated alumina / narrow pore silica gel / CaX zeolite$$

$$activated alumina / narrow pore silica gel / CaX zeolite / 5 A zeolite$$

$$activated carbon / low ash carbon ( e . g . petroleum pitch carbon ) / 5 A zeolite$$

The gas feed to the PSA system originates from an ammonia cracking reactor and typically has from 0 vol. % to about 0.5 vol. % water and from about 0.1 vol. % to about 5 vol. % ammonia with the remainder of the gas consisting essentially of a mixture of hydrogen and nitrogen in a ratio of about 3:1.

The operating temperature of an ammonia cracking reactor is typically high, usually in the range of about 250° C. to about 800° C., e.g. from about 400° C. to about 600° C., and thus the effluent gas needs to be cooled before being fed to the PSA system. In this regard, the cooled effluent gas is typically at a temperature in a range from about 15° C. to about 100° C., e.g. about 50° C.

The operating pressure of an ammonia cracking reactor is also typically high, usually in the range from about 5 bar to about 50 bar, e.g. from about 10 bar to about 40 bar. Since the effluent gas is therefore at an elevated pressure already, pressure adjustment is typically not required before the gas is fed to the PSA system. Thus, the elevated pressure of the cooled effluent gas is usually in a range from about 5 bar to about 50 bar, e.g. from about 10 bar to about 40 bar.

Typically, the PSA tail gas has a back pressure in a range from about 0.2% to about 20% of the elevated pressure of the effluent gas.

According to a second aspect of the present invention, there is provided a PSA unit for separating hydrogen gas from an effluent gas of an ammonia cracking reactor operating at an elevated pressure, said PSA unit comprising a feed end, a product end downstream from the feed end and an adsorbent bed located therebetween, the adsorbent bed comprising an upstream layer of non-zeolitic adsorbent that is selectively adsorbent for at least ammonia and a downstream layer of zeolitic adsorbent that is selectively adsorbent for nitrogen.

According to a third aspect of the present invention, there is provided a PSA system for separating hydrogen gas from an effluent gas of an ammonia cracking reactor operating at an elevated pressure, said PSA system comprising at least two PSA units according to the second aspect in parallel. The PSA system may comprise at least four of such PSA units in parallel.

Non-zeolitic adsorbents that are suitable for use in the PSA unit are as described above.

According to a fourth aspect of the present invention, there is provided apparatus for producing hydrogen from ammonia, comprising:
a pump for pressurizing liquid ammonia;
at least one first heat exchanger in fluid communication with the pump for heating (and optionally vaporizing) the liquid ammonia from the pump by heat exchange with one or more hot fluids to produce heated ammonia;
catalyst-containing reactor tubes in fluid communication with the first heat exchanger(s), for cracking heated ammonia from the first heat exchanger(s) to produce a first cracked gas containing hydrogen gas, nitrogen gas and residual ammonia;
a furnace in thermal communication with the catalyst-containing reactor tubes for combustion of a fuel to heat the catalyst-containing reactor tubes and to form a flue gas;
a cracked gas conduit for feeding cracked gas from the catalyst-containing reactor tubes to the first heat exchanger(s);
a flue gas conduit for feeding flue gas from the furnace to the first heat exchanger(s); and
a first PSA system according to the third aspect of the present invention in fluid communication with the catalyst-containing reactor tubes for purifying cooled cracked gas after passage through the at least one heat exchanger to produce a first hydrogen product gas and a first PSA tail gas;
a first PSA tail gas conduit for removing first PSA tail gas from the first PSA system; and
a first hydrogen product gas conduit for removing first hydrogen product gas from the first PSA system.

In some embodiments, the apparatus comprises a compressor in fluid communication with the first PSA system for compressing first PSA tail gas to produce compressed PSA tail gas; and a recycle conduit for recycling the compressed PSA tail gas to the first PSA system. In these embodiments, there is typically a first PSA tail gas recycle conduit for recycling first PSA tail gas from the first PSA device to the furnace, optionally after passage through the heat exchanger(s).

In other embodiments, the apparatus comprises a compressor in fluid communication with the first PSA system for compressing first PSA tail gas to produce compressed PSA tail gas; a second PSA system in fluid communication with the compressor for purifying the compressed PSA tail gas to produce a second PSA tail gas and a second hydrogen product gas; a second hydrogen gas conduit for removing the second hydrogen gas from the second PSA system; and a second PSA tail gas conduit for removing the second PSA tail gas from the second PSA device. The second PSA system may also be in accordance with the third aspect of the present invention, or may have a different arrangement of layers in the adsorbent bed.

In these embodiments, the first and second hydrogen product gas conduits may combine to form a combined hydrogen product gas conduit. Additionally or alternatively, the second PSA tail gas conduit may recycle the second PSA tail gas from the second PSA system to the furnace, optionally after passage through the heat exchanger(s).

The PSA system is capable of operating using any suitable PSA cycle. Particularly suitable PSA cycles include any of the cycles disclosed in U.S. Pat. Nos. 9,381,460, 6,379,431 and 8,778,051, the disclosures of which is incorporated herein by reference.

In embodiments in which at least the first PSA system comprises at least four PSA units in parallel, the PSA system may operate the PSA cycle disclosed in U.S. Pat. No. 8,778,051. The repetitive cycle comprises, in sequence, (a) a feed step, (b) a first pressure decreasing equalization step, (c) a provide purge step, (d) a blowdown step, (e) a purge step, (f) a first pressure increasing equalization step, and (g) a re-pressurization step. These steps are defined as follows.

The feed step (a) comprises introducing the cooled effluent gas at a feed gas pressure ranging from about 10 bar to about 50 bar into an adsorption bed undergoing step (a) and adsorbing moisture, ammonia and nitrogen in the adsorption bed undergoing step (a) while simultaneously withdrawing a hydrogen product gas from the adsorption bed undergoing step (a).

The first pressure decreasing equalization step (b) comprises co-currently withdrawing a pressure equalization gas from an adsorption bed undergoing step (b), and passing the pressure equalization gas to an adsorption bed undergoing step (f) thereby equalizing the pressure between the adsorbent beds undergoing steps (b) and (f).

The provide purge step (c) comprises co-currently withdrawing a purge gas from an adsorption bed undergoing step (c) and passing the purge gas from the adsorption bed undergoing step (c) to an adsorption bed undergoing step (e).

The blowdown step (d) comprises counter-currently withdrawing a blowdown gas from an adsorption bed undergoing step (d), the blowdown gas having a concentration of moisture, ammonia and nitrogen that is higher than the concentration of these components in the cooled effluent gas feed.

The purge step (e) comprises counter-currently introducing the purge gas from the adsorption bed undergoing step (c), into an adsorption bed undergoing step (e) and counter-currently withdrawing a purge gas effluent from the adsorption bed undergoing step (e), the purge gas effluent having a concentration of moisture, ammonia and nitrogen that is higher than the concentration of these components in the cooled effluent gas feed.

The first pressure increasing equalization step (f) comprises counter-currently introducing the pressure equalization gas from the adsorption bed undergoing step (b) into the adsorption bed undergoing step (f).

The re-pressurisation step (g) comprises increasing the pressure in an adsorption bed undergoing step (g) until the adsorption bed undergoing step (g) is substantially at the feed gas pressure, by at least one of co-currently introducing the cooled effluent gas into the adsorption bed undergoing step (g), and counter-currently introducing a portion of the product gas from the adsorption bed undergoing step (a) into the adsorption bed undergoing step (g).

The process comprises at least one of (i) step (b) further comprising co-currently introducing a rinse gas simultaneously with the withdrawing of the pressure equalization gas, and (ii) step (c) further comprises co-currently introducing a rinse gas simultaneously with the withdrawing of the purge gas. The rinse gas is formed by compressing at least a portion of at least one of the blowdown gas from the adsorption bed undergoing step (d) and the purge gas effluent from the adsorption bed undergoing step (e).

The first pressure increasing equalization step (f) further comprises at least one of (i) co-currently introducing the feed gas mixture into the adsorbent bed undergoing step (f) simultaneously with the counter-current introduction of the pressure equalization gas from the adsorption bed undergoing step (b), and (ii) counter-currently introducing product gas from at least one of the adsorbent beds undergoing step (a) into the adsorption bed undergoing step (f) simultaneously with the counter-current introduction of the pressure equalization gas from the adsorption bed undergoing step (b).

The invention will now be described with reference to embodiments depicted in the following figures.

### BRIEF DESCRIPTION OF THE FIGURES

FIG. 1 is a process flow diagram of a first example of an ammonia cracking process to produce hydrogen that can utilize the present invention;

FIG. 2 is a process flow diagram of a second example of an ammonia cracking process to produce hydrogen that can utilize the present invention; and

FIG. 3 is a process flow diagram of a third example of an ammonia cracking process to produce hydrogen that can utilize the present invention.

### DETAILED DESCRIPTION OF THE INVENTION

A process is described herein for producing hydrogen by cracking ammonia. The process has particular application to producing so-called “green” hydrogen which is hydrogen created using renewable energy instead of fossil fuels. In this case, the ammonia is typically produced by electrolyzing water using electricity generated from renewable energy, such as wind and/or solar energy, to produce hydrogen which is then reacted catalytically with nitrogen (Haber process) to produce the ammonia which is more easily transported than hydrogen. After reaching its destination, the ammonia is then cracked to regenerate the hydrogen.

In this process, the heat required for the reaction is typically provided by combustion of PSA tail gas (which usually contains some amount of residual hydrogen and ammonia) in the furnace. If the PSA tail-gas has insufficient heating value than either vaporised ammonia, a portion of the product hydrogen, or an alternative fuel may be used with the tail-gas as a trim fuel.

In practice, natural gas could be used as a trim fuel, together with the PSA tail gas, as is practiced in SMRs for hydrogen. However, with the desire to maintain the “green” or renewable credentials of the hydrogen so produced, there is an incentive to use a “renewable fuel”. This can be the cracked “renewable” ammonia, the ammonia itself, or another renewable energy source, such as biogas, or indeed electric heating whether the electricity is itself from a renewable source, in this case local to the cracking process as opposed to the renewable electricity used to generate the hydrogen which has been transported in the form of ammonia.

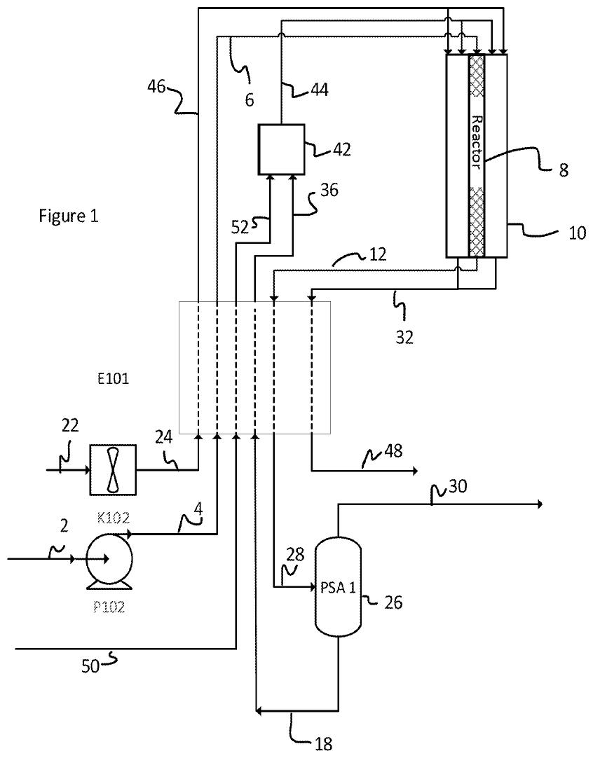

An example of the process is shown in FIG. 1. The process takes liquid ammonia from storage (not shown). The ammonia to be cracked (line 2) is pumped (pump P201) as liquid to a pressure greater than the desired cracking pressure (see GB1142941). The reaction pressure is a compromise between operating pressure and conversion according to Le Chatelier's principle. There is an incentive to operate the reactor (8) at higher pressure because pumping liquid ammonia requires less power and capital than compressing the product hydrogen.

The pressurised liquid ammonia (line 4) is then heated, vaporised (if it is below its critical pressure) and heated further, up to a temperature of greater than 250° C. via a heat exchanger (E101) using the heat available in the cracked gas leaving the reaction tubes and the flue gas from the furnace. In the figure, the heat exchanger (E101) is shown as one heat exchanger but, in practice, it will be a series of heat exchangers in a network.

The initial heating and vaporization of the pressurized liquid ammonia may alternatively take place against an alternative heat source, such as cooling water or ambient air. Typical reaction temperatures are greater than 500° C. (see U.S. Pat. No. 2,601,221), palladium-based systems can run at 600° C. and 10 bar, whereas RenCat's metal oxide-based system runs at less than 300° C. and 1 bar. (See https://www.ammoniaenergy.org/articles/ammonia-cracking-to-high-purity-hydrogen-for-pem-fuel-cells-in-denmark/). The operating pressure of the cracker is typically an optimization of several factors. Cracking of ammonia into hydrogen and nitrogen is favored by low pressure but other factors favor higher pressure, such as power consumption (which is minimized by pumping the feed ammonia rather than compressing the product hydrogen), and the PSA size (which is smaller at higher pressure).

The hot ammonia (line 6) enters catalyst-containing reaction tubes of a reactor (8) at the desired pressure where additional heat is provided by the furnace (10) to crack the ammonia into nitrogen and hydrogen. The resulting mixture of residual ammonia, hydrogen and nitrogen exits (line 12) the reaction tubes of the reactor (8) at the reaction temperature and pressure. The reaction products are cooled in a heat exchanger (E101) against a combination of feed ammonia (from line 4), furnace fuel (in this case natural gas from line 50) and combustion air (from line 22, fan K201 and line 24) to reduce the temperature as close as possible to that required for the inlet of a PSA system (26). Any residual heat in the cracked gas mixture (line 28) is removed in a water cooler (not shown) to achieve an inlet temperature to the PSA system (26) of in a range from about 20° C. to about 100° C., e.g. about 50° C.

The PSA system (26) comprises a plurality of PSA units (not shown), each with an adsorbent bed according to the present invention. Thus, each PSA unit comprises a feed end, a product end downstream from the feed end and an adsorbent bed located therebetween. The adsorbent bed comprises an upstream layer of non-zeolitic adsorbent that is selectively adsorbent for at least ammonia, such as an activated carbon, and a downstream layer of zeolitic adsorbent that is selectively adsorbent for nitrogen, such as a molecular sieve. The bed may also contain a further layer of water adsorbent material at the feed end of the bed, optionally together with a second layer of zeolitic adsorbent at the product end of the bed. Finally, there may also be an intermediate layer of “low ash” carbon located between the so-called upstream and downstream layers.

The PSA product (line 30) is pure hydrogen compliant with ISO standard 14687—Hydrogen Fuel Quality—with residual ammonia<0.1 ppmv and nitrogen<300 ppmv—at approximately the reaction pressure. The product hydrogen (line 30) is further compressed (not shown) for filling into tube trailers (not shown) for transport or it may be liquefied in a hydrogen liquefier (not shown) after any required compression. The PSA tail gas (line 18) or “purge gas” from the PSA device (26) is shown as being heated via the heat exchanger E101, using the cracked gas (line 12) leaving the reaction tubes of the reactor (8) or furnace flue gas (line 32), before being sent (in line 36) to the furnace (10) as a combustion fuel. However, the PSA tail gas (line 18) may be fed directly to the furnace (10) without heating.

The resultant warmed natural gas fuel (line 52) is depicted as combined with the (optionally) warmed PSA tail gas (line 36) in a mixer (42) to produce a combined fuel which is fed (line 44) to the furnace (10) for combustion to generate the flue gas (line 32 and, after cooling in E101, line 48). However, it should be noted that one or more of the fuels could be fed directly to the furnace without prior mixing. The warmed air (for combustion of the fuel) is fed to the furnace (10) in line 46.

One of the aims of preferred embodiments of the process is to maximise the amount of hydrogen generated by cracking the renewable ammonia. That means minimising the amount of hydrogen used as fuel, or ammonia if ammonia were to be used as a fuel directly. Therefore, heat integration is important so as to use the hot flue gas and cracked gas appropriately, for instance to preheat air (line 24) and ammonia (line 4) to the cracker as this reduces the amount of “fuel” to be used in the burners of the furnace (10). This leads to higher hydrogen recovery as less of the hydrogen is lost in the furnace flue gas (lines 32 & 48) as water. Therefore, steam generation, for instance, should be minimised in favour of intra-process heat integration.

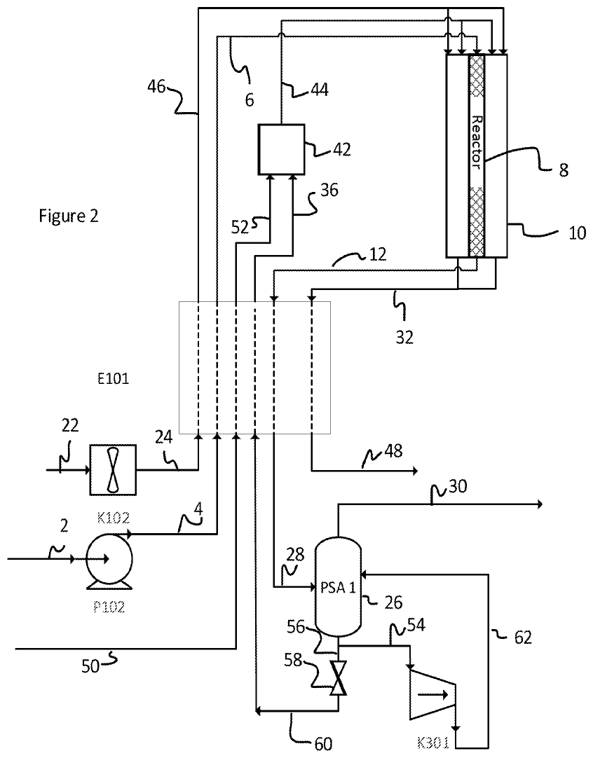

FIG. 2 depicts a similar process to that of FIG. 1. All of the common features of the processes depicted in FIGS. 1 and 2 have been given the same reference numerals. The following passages discuss the features that distinguish FIG. 2 over FIG. 1.

In FIG. 2, the PSA tail gas from the PSA system (26) is divided into two parts. The first part (line 56) is fed via valve 58, line 60 and line 36, as fuel to the furnace (10)—in line with the process of FIG. 1, in which line 18 is equivalent to line 60 in FIG. 2. Valve 58 may be used to control the flow of PSA tail gas in line 60 and hence the ratio of the amount of PSA tail gas to the amount of natural gas in the fuel mixture fed to the furnace (10).

Varying the amount and composition of the fuel being combusted in the furnace (10) varies the carbon intensity of the cracking process which in turn permits control of the overall carbon intensity value of the hydrogen product. In this way, it is possible to keep the overall carbon intensity value below a certain pre-determined limit such as that specified by a regulatory authority for “renewable hydrogen” in the face of variations in carbon intensity upstream of the process.

The second part (line 54) is compressed in compressor K301 to form a compressed tail gas which is returned (line 62) to the PSA system (26) for further processing.

The PSA system in FIG. 1 is capable of recovering from about 75% to about 85% hydrogen. Returning the PSA tail gas to the PSA system improves recovery of hydrogen. Recycling the PSA tail gas in this way can achieve an overall hydrogen recovery of about 94% to about 96%.

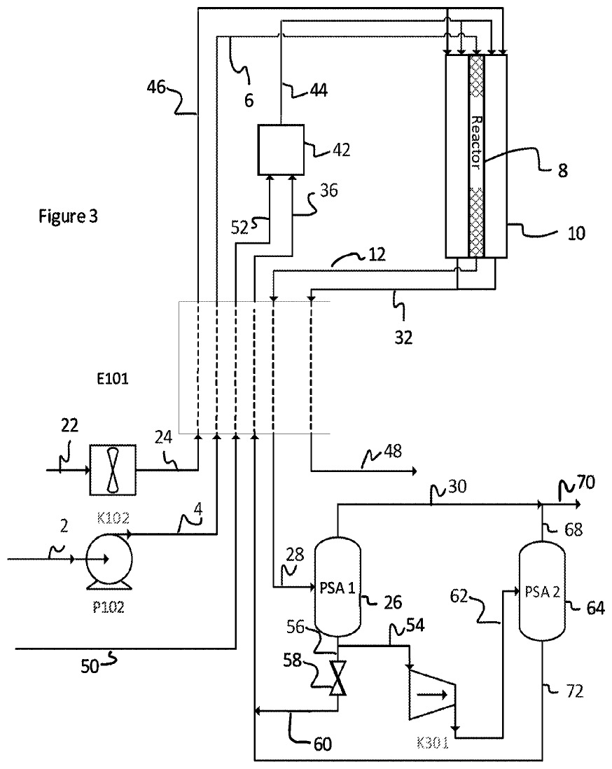

FIG. 3 depicts a similar process to that of FIGS. 1 and 2. All of the common features of the processes depicted in FIGS. 1 to 3 have been given the same reference numerals. The following passages discuss the features that distinguish FIG. 3 over both FIGS. 1 and 2.

In FIG. 3, the second part of compressed PSA tail gas (line 62) is fed to a second PSA system (64) where it is separated into a second substantially pure hydrogen product gas (line 68) and a second PSA tail gas (line 72).

The second PSA system (64) comprises a plurality of PSA units (not shown), each with an adsorbent bed according to the present invention. Thus, each PSA unit comprises a feed end, a product end downstream from the feed end and an adsorbent bed located therebetween. The adsorbent bed comprises an upstream layer of non-zeolitic adsorbent that is selectively adsorbent for at least ammonia, such as an activated carbon, and a downstream layer of zeolitic adsorbent that is selectively adsorbent for nitrogen, such as a molecular sieve. The bed may also contain a further layer of water adsorbent material at the feed end of the bed, optionally together with a second layer of zeolitic adsorbent at the product end of the bed. Finally, there may also be an intermediate layer of “low ash” carbon located between the so-called upstream and downstream layers.

The second hydrogen product gas can be combined with the first hydrogen product gas (line 30) to form a combined hydrogen product gas (line 70).

The second PSA tail gas (line 72) is combined with the second part (line 60) of the PSA off gas from the first PSA system (26) and the combined stream is fed as fuel to the furnace (10). Further processing in this way can achieve an overall hydrogen recovery of about 95% to about 97%.

For example, if the first PSA system achieves 83% recovery and the second PSA system achieves 80% recovery, then the overall recovery is 96.6%.

Another difference between the processes of FIGS. 2 and 3 is that valve 58 in FIG. 2 must remain open to some extent to allow some PSA tail gas from the first PSA system to be used as fuel in the furnace (10) whereas the valve 58 in FIG. 3 can shut-off completely flow of PSA tail gas from the first PSA system to the furnace because there will always be flow of PSA tail gas from the second PSA system (64) to the furnace.

The invention will now be illustrated with reference to the following examples.

### EXAMPLES

Adsorbents for ammonia removal in a hydrogen PSA process were characterized using a dynamic adsorption apparatus. The experimental system used:
a packed column of adsorbent;
flow control devices;
pressure control devices; and
ammonia concentration analyser.

The experimental method consisted of:
first purging the packed column with a 50:50 mixture of hydrogen gas and nitrogen gas;
introducing flowing gas of 500 ppm ammonia in a dilution gas of a 50:50 mixture of hydrogen gas and nitrogen gas at 10 bar through the packed column;
monitoring the ammonia concentration at the exit of the packed column until the concentration of ammonia reached 500 ppm;
depressurizing the packed column to 1.4 bar;
purging the packed column with flowing nitrogen gas at 1.4 bar; and
monitoring the ammonia concentration at the exit of the packed column until the concentration of ammonia reached 0 ppm.

The empty column residence time for the experiments was 3.4 s for the ammonia adsorption step and 1.3 s for the nitrogen purge step.

The rate of ammonia adsorption on these materials was relatively fast. Except for the polymer-derived carbon and the carbon made from petroleum pitch, the rate of desorption of ammonia was slow. The Henry's Law Constant, which is region of adsorption in which the amount adsorbed is directly proportional the partial pressure of the adsorbate, for ammonia was extracted from the experimental data.

Acid-treated coconut shell carbon was prepared by treating coconut shell carbon with hydrochloric acid by soaking 125 g of the coconut shell carbon in 300 ml 3% HCl (aq) for 2 hours at 25° C. The carbon was then filtered, resuspended in 300 ml deionized water, soaked for 30minutes and then filtered. The deionized water rinse/filtration process was repeated 4 times until the final pH of the air-dried carbon reached 6.2. The air-dried carbon was heated to 150° C. overnight to remove adsorbed water and carbon dioxide before being tested.

The base-treated coconut shell carbon was preparing by impregnating coconut shell carbon with 3% NaOH (aq) by incipient wetness. The impregnated carbon was air dried, then activated at 150° C. overnight prior to testing. The capacity for ammonia at 40° C. and 0.005 bar increased, but the amount desorbed in 600 s of purge was the same as the untreated sample.

Coconut shell carbon was also treated in situ in flowing nitrogen at 150° C., then 340° C.

The working capacity of an adsorbent for ammonia in a PSA cycle depends on how much is adsorbed during the adsorption step and how easily it is desorbed in the purge step. The overall PSA performance for the purification of hydrogen from a cracked gas depends on several factors, including: the adsorptive capacity for hydrogen, the adsorptive capacity for nitrogen and the density in the packed column. The following data are related to those aspects.

The results obtained in the experiments are summarized in Table 2.

TABLE 2

| | Ammonia | | | 40° C. |
|---|---|---|---|---|
| | Capacity | Ammonia | Ammonia | Henry's |
| | 0.005 bar | Desorbed | Desorbed | Law Constant |
| | 40° C. | in 100 s | in 600 s | for Ammonia |
| Adsorbent | mmol/g | mmol/g | mmol/g | mmol/g/bar |
| Synthetic Carbon | 0.015 | 0.007 | 0.014 | — |
| Petroleum Pitch | 0.016 | 0.008 | 0.015 | — |
| Carbon | | | | |
| Coal-Based Carbon | 0.050 | 0.009 | 0.033 | 240 |
| Acid Treated | 0.10 | 0.010 | 0.035 | — |
| Coconut | | | | |
| Shell Carbon | | | | |
| Coconut Shell | 0.10 | 0.009 | 0.047 | — |
| Carbon | | | | |
| (30° C.) | | | | |
| Coconut Shell | 0.11 | 0.009 | 0.051 | 790 |
| Carbon | | | | |
| (150° C.) | | | | |
| Coconut Shell | 0.19 | 0.009 | 0.059 | — |
| Carbon | | | | |
| (340° C.) | | | | |
| 3 wt % NaOH | 0.25 | 0.008 | 0.058 | — |
| Coconut | | | | |
| Shell Carbon | | | | |
| (340° C.) | | | | |
| K₂CO₃-treated | 0.21 | 0.009 | 0.055 | — |
| Activated | | | | |
| Alumina | | | | |
| Activated | 0.23 | 0.009 | 0.056 | 230 |
| Alumina | | | | |
| Wide Pore | 0.50 | 0.020 | 0.120 | 360 |
| Silica Gel | | | | |
| Small Pore | 1.75 | 0.013 | 0.104 | 2020 |
| Silica Gel | | | | |
| Silicalite | — | 0.012 | 0.083 | — |
| Binderless | >2.5 | 0.015 | 0.062 | — |
| 5A Zeolite | | | | |

By way of comparison, binderless 5A zeolite has an ammonia capacity at 0.005 bar and 40° C. of more than 2.5 mmol/g. In addition, only 0.015 mmol/g (i.e. less than 0.5%) of the adsorbed ammonia is desorbed in 100 s and only 0.062 mmol/g (i.e. less than 2.5%) of the adsorbed ammonia is desorbed in 600 s.

The results were analyzed using an in-house dynamic simulation program for adsorption processes. The dynamic simulation program numerically solves the mass and energy balances by discretization of each layer into equal-sized nodes, thereby reducing the partial differential equations to ordinary differential equations. The physics of momentum transfer, and equilibrium adsorption within each node are represented by standard models for these phenomena, such as the Ergun and Langmuir equations. Through simulation of the dynamic ammonia adsorption/desorption experiments, model constants were extracted. The dynamic simulation program was then used to assess the performance of these materials in an industrial scale hydrogen PSA process.

The effectiveness of several adsorbents for the removal of ammonia from ammonia cracking reactor effluent was evaluated through dynamic simulation of a hydrogen PSA process. The feed gas to the hydrogen PSA process was 0.1 mol % water, 1.2 mol % ammonia, 24.7 mol % nitrogen, 74.0 mol % hydrogen at 45° C. and 20 bar. The cycle simulated was that disclosed in FIG. 22 of U.S. Pat. No. 9,381,460 with a feed time (P/SP) of 150 seconds. The back pressure on the waste gas was 1.45 bar. Ammonia removal in the process was simulated using adsorption models with parameters extracted from experimental results summarized in Table 1. The amount of ammonia adsorbent was varied such that the level of ammonia at the end of the adsorbent layer was 0.1 ppm at the end of the feed (adsorption) step. Nitrogen removal in the process was simulated using adsorption models and parameters representative of a 5A molecular sieve. The amount of nitrogen adsorbent was varied to achieve an impurity of 50 ppm nitrogen in the hydrogen product.

The simulation results are summarized in Table 3, which shows the effectiveness of these adsorbents for ammonia removal, and Table 4, which shows the overall PSA performance of the ammonia absorbent plus nitrogen adsorbent for the purification of hydrogen to 50 ppm nitrogen.

TABLE 3

| | Ammonia | | Nitrogen |
|---|---|---|---|
| | Capacity | Ammonia | Capacity |
| | 40° C. | Working | 40° C. |
| | 0.24 bar | Capacity | 5 bar |
| Adsorbent | mmol/g | mmol/g | mmol/g |
| Coal-Based Carbon | 1.0 | 0.077 | 0.75 |
| Coconut Shell | 1.4 | 0.111 | 1.09 |
| Carbon | | | |
| (150° C.) | | | |
| Activated Alumina | 2.0 | 0.056 | 0.08 |
| Wide Pore Silica Gel | 1.1 | 0.089 | 0.07 |
| Small Pore Silica Gel | 4.4 | 0.097 | 0.18 |

The Hydrogen Productivity of the system is the ratio of the flow of purified hydrogen, in tonnes per day (or TPD), coming from one adsorber vessel to the volume of adsorbent in that vessel.

TABLE 4

| | | Hydrogen |
|---|---|---|
| | Hydrogen | Productivity |
| Adsorbent | Recovery | TPD H₂/m³ ads |
| Coal-Based Carbon | 85.6% | 0.60 |
| Coconut Shell | 86.1% | 0.61 |
| Carbon (150 C.) | | |
| Activated Alumina | 84.9% | 0.55 |
| Wide Pore Silica Gel | 84.2% | 0.52 |
| Small Pore Silica Gel | 86.4% | 0.61 |

The effectiveness of the ammonia removal adsorbent is gauged by the Ammonia Working Capacity at cyclic steady state, which is the ratio of the amount of ammonia, in mmol, introduced to the adsorbent during the feed step to the mass of adsorbent, in grams, in the simulated vessel. The working capacity is the difference between the amount of ammonia in the adsorber vessel at the end of the feed (adsorption) step and the amount of ammonia in the adsorber vessel at the end of the regeneration step. The results show that carbon, activated alumina, and silica gel are all suitable for the removal of ammonia in hydrogen PSA processes.

The decision to select one depends on several factors, including cost and stability in the presence of ammonia and water vapor. The adsorptive capacity for nitrogen, also listed in Table 2, will also dictate the proper selection of the ammonia adsorbent for this process. Compared to alumina and silica gel, activated carbon has significantly higher adsorption capacity for nitrogen. Nitrogen adsorption in this first layer will decrease the amount of nitrogen removal required by the second layer.

While the ammonia capacity of the polymer-derived carbon, formed by carbonization of polymer beads (see US2011296990), and the petroleum pitch carbon is low, nearly all the ammonia adsorbed at 40° C. and 0.005 bar was released after 600 s of nitrogen purge at 1.4 bar and 40° C. A much lower fraction is desorbed from the coal-based and coconut shell carbons under the same purge conditions.

The polymer-derived carbon and petroleum pitch carbon have much lower inorganic ash content than the coal based and coconut shell carbon (Table 4). These low-ash carbons are formed by heating to 300 to 900° C. in the absence of oxygen either polymer beads, such as those composed of polystyrene(co)polymer, or petroleum pitch, a viscoelastic polymer derived from petroleum.

TABLE 5

| | Ammonia | | | |
|---|---|---|---|---|
| | Capacity | Ammonia | Inorganic | Zero |
| | 0.005 atm | Desorbed | Content | Point of |
| | 40° C. | in 600 s | ASTM | Charge |
| Adsorbent | mmol/g | mmol/g | D 2866 | pH |
| Synthetic Carbon | 0.015 | 0.014 | 0.05% | 8.8 |
| Petroleum Pitch | 0.016 | 0.015 | 0.1% | 8.6 |
| Carbon | | | | |
| Wood-Based | — | — | — | — |
| Carbon | | | | |
| Coal-Based | 0.050 | 0.033 | 7% | 8.7 |
| Carbon | | | | |
| Acid Treated | 0.10 | 0.035 | — | 6.3 |
| Coconut Shell | | | | |
| Carbon | | | | |
| Coconut Shell | 0.10 | 0.051 | 3% | 9.8 |
| Carbon (30 C.) | | | | |
| 3 wt % NaOH | 0.25 | 0.058 | — | 10.7 |
| Coconut Shell | | | | |
| Carbon (30 C.) | | | | |

Because the ammonia is readily desorbed, the polymer-derived carbon or petroleum pitch carbon can be utilized as second carbon layer between a first carbon layer with high ammonia adsorption capacity and the layer of molecular sieve used for adsorption of nitrogen in the PSA process. With easy desorption from the polymer-derived carbon during the purge step, such a layering will prevent the ammonia from reaching the molecular sieve. With its very high capacity for ammonia at low pressure, ammonia is not readily desorbed from molecular sieve. Ammonia will continue to accumulate on the molecule sieve layer, decreasing its capacity for nitrogen.

The percentage of desorbed ammonia at 100 s versus ZPC for different non-zeolitic adsorbents is plotted below. These data show that non-zeolitic adsorbents having ZPC values in the range from about pH 6.3 to about pH 9.8, and particularly in the range from about pH 8 to about pH 9,would be suitable to remove ammonia in the adsorbent bed of a hydrogen PSA tasked with purifying the effluent gas of an ammonia cracking reactor.

### Example 1

The dynamic simulation program with models and parameters for the adsorption of ammonia and nitrogen on the coal-based carbon and parameter for the adsorption of nitrogen on 5A molecular sieve was used to demonstrate a process providing a stream of purified hydrogen.

The adsorption cycle was that shown in Table 5 of U.S. Pat. No. 6,379,431.

The feed gas to the hydrogen PSA system was 3 mol % ammonia, 24.2 mol % nitrogen, and 72.8 mol % hydrogen at 34 bar and 40° C. The adsorbents were regenerated with 1.4 bar back pressure during the blowdown and purge steps. Each adsorber vessel was 6 feet (1.8 m) in diameter. 10 feet (3.0 m) of coal-based carbon was used to decrease the ammonia to 0.1 ppm. 20.5 feet (6.2 m) of 5A molecular sieve was used to decrease the nitrogen level to 50 ppm. The adsorption time was 100 s. The hydrogen recovery from this first PSA system was 83.3%.

The waste gas from this first PSA system contained 7.6 mol % ammonia, 61.5 mol % nitrogen, 30.9 mol % hydrogen. The flow was 988 kmol/h. The dynamic simulation program was used for the adsorption of ammonia and nitrogen of this stream following compression to 34 bar and cooling to 40° C. 6 feet (1.8 m) of coal-based carbon was used to decrease the ammonia to 0.1 ppm. 24.5 feet (7.5 m) of 5A molecular sieve was used to decrease the nitrogen level to 50 ppm. The hydrogen recovery from this second PSA operating on the waste gas from the first PSA was 78.5%.

The overall hydrogen recovery from the two PSA systems operating in series (such as that depicted in FIG. 3) was 96.4%. The hydrogen flow rate was 85 tonne/day.

### Example 2

The dynamic simulation program with models and parameters for the adsorption of ammonia and nitrogen on the coal-based carbon and for the adsorption of nitrogen on 5A molecular sieve was used to demonstrate a process providing a stream of substantially pure hydrogen.

The adsorption cycle was that shown in FIG. 13 of U.S. Pat. No. 8,778,051. A portion of the tail gas was compressed and introduced the adsorber vessels undergoing concurrent depressurizations eq1d and eq2d. The flow to the adsorber vessels during eq1d and eq2d was 594 kmol/h.

The feed gas to the hydrogen PSA system was 3 mol % ammonia, 24.2 mol % nitrogen, and 72.8 mol % hydrogen at 34 bar and 40° C. The adsorbents were regenerated with 1.4 bar pressure during the blowdown and purge steps. Each adsorber vessel was 7 feet (2.1 m) in diameter. 10 feet (3.0 m) of coal-based carbon was used to decrease the ammonia to 0.1 ppm. 19.5 feet (5.9m) of 5A molecular sieve was used to decrease the nitrogen level to 50 ppm. The adsorption time was 100 s.

The hydrogen recovery from this PSA system (such as that depicted in FIG. 2) was 94.3%. The pure hydrogen flow rate was 85 tonne/day.

The present invention is not to be limited in scope by the specific aspects or embodiments disclosed in the examples which are intended as illustrations of a few aspects of the invention and any embodiments that are functionally equivalent are within the scope of this invention. Various modifications of the invention in addition to those shown and described herein will become apparent to those skilled in the art and are intended to fall within the scope of the appended claims.

1-47. (canceled)

48. A method of separating hydrogen gas from an effluent gas of an ammonia cracking reactor operating at an elevated pressure, in a pressure swing adsorption (PSA) system comprising at least two PSA units in parallel,
said method comprising:
cooling the effluent gas by heat exchange to produce cooled effluent gas; and
feeding the cooled effluent gas at the elevated pressure to the PSA system to produce a hydrogen product gas and a PSA tail gas;
wherein each PSA unit comprises a feed end, a product end downstream from the feed end and an adsorbent bed located therebetween, the adsorbent bed comprising an upstream layer of non-zeolitic adsorbent that is selectively adsorbent for at least ammonia and a downstream layer of zeolitic adsorbent that is selectively adsorbent for nitrogen.

49. A method according to claim 48, wherein the non-zeolitic adsorbent has a capacity for ammonia of at least 0.01 mmol/g at 0.005 bar and 40° C.

50. A method according to claim 48, wherein the non-zeolitic adsorbent desorbs at least 10% of adsorbed ammonia after 100 s using a nitrogen purge at 1.4 bar and 40° C.

51. A method according to claim 48, wherein the non-zeolitic adsorbent desorbs at least 30% of adsorbed ammonia after 600 s using a nitrogen purge at 1.4 bar.

52. A method according to claim 48, wherein the non-zeolitic adsorbent selectively co-adsorbs water and/or nitrogen.

53. A method according to claim 52, wherein the non-zeolitic adsorbent has a capacity for nitrogen of at least 0.18 mmol/g at 5 bar and 40° C.

54. A method according to claim 48, wherein the non-zeolitic adsorbent has a surface acidity in the range from about pH 6.3 to about pH 9.8.

55. A method according to claim 48, wherein the non-zeolitic adsorbent is an activated carbon.

56. A method according to claim 55, wherein the activated carbon is selected from the group consisting of polymer-derived carbon, petroleum pitch carbon, wood-based carbon, coal-based carbon and coconut shell carbon.

57. A method according to claim 56, wherein the activated carbon is pre-treated with acid or base.

58. A method according to claim 56, wherein the activated carbon is pre-treated in situ by flowing nitrogen through the layer of coconut shell at an elevated temperature of at least 150° C.

59. A method according to claim 55, wherein the activated carbon has an inorganic content of less than 1 wt. %.

60. A method according to claim 48, wherein the non-zeolitic adsorbent is activated alumina.

61. A method as claimed in claim 60, wherein the activated alumina is pre-treated with base.

62. A method according to claim 48, wherein non-zeolitic adsorbent is selected from the group consisting of wide pore silica gel, narrow pore silica gel and silicalite.

63. A method according to claim 48, wherein the adsorbent bed comprises an intermediate layer of activated carbon having an inorganic content of less than 1% located between the upstream and downstream layers.

64. A method according to claim 48, wherein the activated carbon of the intermediate layer is selected from the group consisting of polymer-derived carbon and petroleum pitch carbon.

65. A method according to claim 48, wherein the effluent gas has from 0% to about 0.5% by volume water and from about 0.1% to about 5% by volume ammonia with the rest of the gas consisting of a mixture of hydrogen and nitrogen in a ratio of about 3:1.

66. A method according to claim 48, wherein the cooled effluent gas is at a temperature in a range from about 15° C. to about 100° C.

67. A method according to claim 48, wherein the elevated pressure of the cooled effluent gas is in a range from about 5 bar to about 40 bar.

68. A method according to claim 48, wherein the PSA tail gas has a back pressure in a range from about 0.2% to about 20% of the elevated pressure of the effluent gas.
